(19) United States
(12) Patent Application Publication
(10) Pub. No.: US 2012/0122002 A1
(43) Pub. Date: May 17, 2012

(54) PHOSPHORIC ACID FUEL CELL WITH INTEGRATED ABSORPTION CYCLE REFRIGERATION SYSTEM

(76) Inventors: Mithun Kamat, Manchester, CT (US); Leslie L. Van Dine, Manchester, CT (US); Joshua D. Isom, South Windsor, CT (US); Sitaram Ramaswamy, West Hartford, CT (US)

(21) Appl. No.: 13/387,027

(22) PCT Filed: Sep. 9, 2009
(86) PCT No.: PCT/US2009/056291

§ 371 Date: Jan. 25, 2012

(51) Int. Cl. H01M 8/04; H01M 8/02; H01M 8/24

(52) U.S. Cl. 429/435

(57) ABSTRACT

A phosphoric acid fuel cell (PAFC) system includes a cell stack assembly having an anode, a cathode and a coolant portion. At least one heat exchanger is fluidly interconnected with at least one of the anode, the cathode and the coolant portion and provides a fluid path for receiving a fluid from the anode, the cathode and/or the coolant portion. An absorption cycle refrigerant system includes an absorber having a solution of refrigerant and absorbent, and an absorbent loop and a refrigerant loop communicating with the absorber and respectively carrying absorbent and refrigerant. The at least one heat exchanger is arranged in the absorbent loop and is configured to transfer heat from the fuel cell system to the absorption chiller.

### BACKGROUND

This disclosure relates to a phosphoric acid fuel cell (PAFC) system. More particularly, the disclosure relates to a PAFC system with an integrated absorption cycle refrigeration system.

A typical phosphoric acid fuel cell power plant design attempts to reject waste heat in a manner that provides good overall efficiency for the power plant. For example, several fuel cell heat exchangers reject heat to produce high grade hot water, and other fuel cell heat exchangers reject heat to produce low grade hot water. More specifically, intermediate water and/or glycol cooling loops are used to transfer heat from fuel cell heat exchangers to hot water heat exchangers. The customer uses the hot water heat exchangers to heat various portions of their facility, if desired.

The fuel cell heat exchangers must be sufficiently cooled to ensure that the fuel cell is able to operate at peak efficiency. In some fuel cell configurations, customer heat exchangers cannot use all of the fuel cell waste heat for heating purposes. To increase heat utilization, it is desirable to use the waste heat to drive an absorption chiller. However, providing heat to an absorption chiller via intermediate heat exchange reduces the efficiency of the absorption chiller. Accordingly, what is needed is a fuel cell power plant design that enables more efficient thermal integration of the absorption chiller, thus enabling higher heat utilization and higher overall system efficiency.

### SUMMARY

A phosphoric acid fuel cell (PAFC) system includes a cell stack assembly having an anode, a cathode and a coolant portion. At least one heat exchanger is fluidly interconnected with at least one of the anode, the cathode and the coolant portion and provides a fluid path for receiving a fluid from the anode, the cathode and/or the coolant portion. An absorption cycle refrigerant system includes an absorber having a solution of refrigerant and absorbent, and an absorbent loop and a refrigerant loop communicating with the absorber and respectively carrying absorbent and refrigerant. The at least one heat exchanger is arranged in the absorbent and is configured to transfer heat from the fuel cell system to the absorption chiller.

These and other features of the disclosure can be best understood from the following specification and one or more drawings, the following of which is a brief description.

### BRIEF DESCRIPTION OF THE DRAWINGS

FIG. 1 is a schematic view of a phosphoric acid fuel cell system including heat exchangers producing waste heat.

FIG. 2 is a schematic view of an absorption refrigerant cycle system integrated with the heat exchangers of the phosphoric acid fuel system shown in FIG. 1.

### DETAILED DESCRIPTION

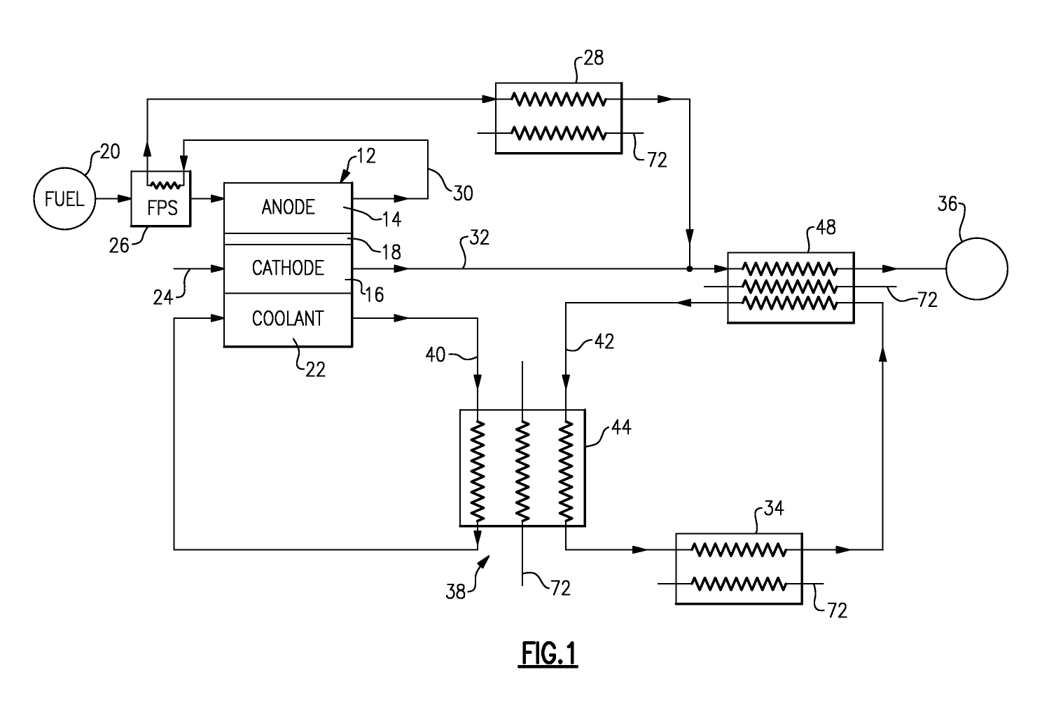

A phosphoric acid fuel cell (PAFC) system 10 is schematically shown in FIG. 1. Many valves, pumps, heat exchangers, fluid connections and other features of the system 10 are omitted for clarity. The system 10 includes a fuel cell 12 having an anode 14 and a cathode 16. The anode 14 and the cathode 16 are separated by an electrolyte 18, which is phosphoric acid in a porous mesh in one example. Only one cell is schematically illustrated; the fuel cell 12 includes multiple cells. The fuel cell 12 uses fuel from a fuel source 20 after reformation in an fuel processing system (FPS) 26. This reformation process generates gas containing hydrogen. The fuel cell 12 also uses oxidant from an oxidant source 24 to produce electricity for a load.

The cell stack assembly 12 also includes a coolant portion 22, which may be a cooling plate arranged between each anode 14 and cathode 16. Several heat exchangers (28, 34, 44 and 48, for example) are fluidly interconnected with the FPS 26, the anode 14, the cathode 16 and the coolant portion 22. Each heat exchanger provides a fluid path receiving a fluid from the anode 14, cathode 16 and/or coolant portion 22.

Process air from the oxidant source 24, which is typically air from the surrounding environment, is supplied to the cathode 16 by a process air blower (not shown). The fuel source 20 is supplied to the anode 14 by a fuel pump (not shown). Typically, the fuel source 20 is a petroleum-based fuel or natural gas. The fuel must be converted to a pre-reformate containing hydrogen that is useable by the anode 14. During the fuel conversion process, heat is generated in the FPS 26 and exchanged in a reformate heat exchanger 28, which is respectively arranged between the FPS 26 and the heat exchanger 48. The fluid received by the reformate heat exchanger 28 is a FPS exhaust stream that is a product of combusting the anode exhaust gas in the FPS 26 to provide the heat needed for reformation. The temperature of the reformate flow entering the anode 14 is controlled to ensure the required fuel cell anode inlet temperature is achieved.

The reformate chemically reacts at the anode 14 and the oxygen chemically reacts at the cathode 16 to electro-chemically produce electricity for the load. An anode exhaust flow 30 contains process water in the form of steam and residual hydrogen not consumed in the fuel cell. Typically, the anode exhaust flow exits from the FPS 26 at approximately 160-250° C. A cathode exhaust 32 exiting the cathode 16 is similarly laden with high temperature steam. A cathode exhaust heat exchanger 48 is in fluid communication with and downstream from the cathode and configured to receive the cathode exhaust 32. The cathode exhaust flow through the cathode exhaust heat exchanger 48 may be provided to a burner 36 for subsequent use by the system 10.

A coolant heat exchanger 44 is arranged in a coolant loop 38 having two sub-loops 40, 42. The first loop 40 receives hot coolant from the coolant portion 22 and provides the coolant to the heat exchanger 44. The second loop 42 is in fluid communication with the cathode exhaust heat exchanger 48, heat exchanger 44 and cooling heat exchanger 34, which further cools the cathode exhaust 32. Valves and/or other control devices are used to control the flow of coolant through the coolant loop.

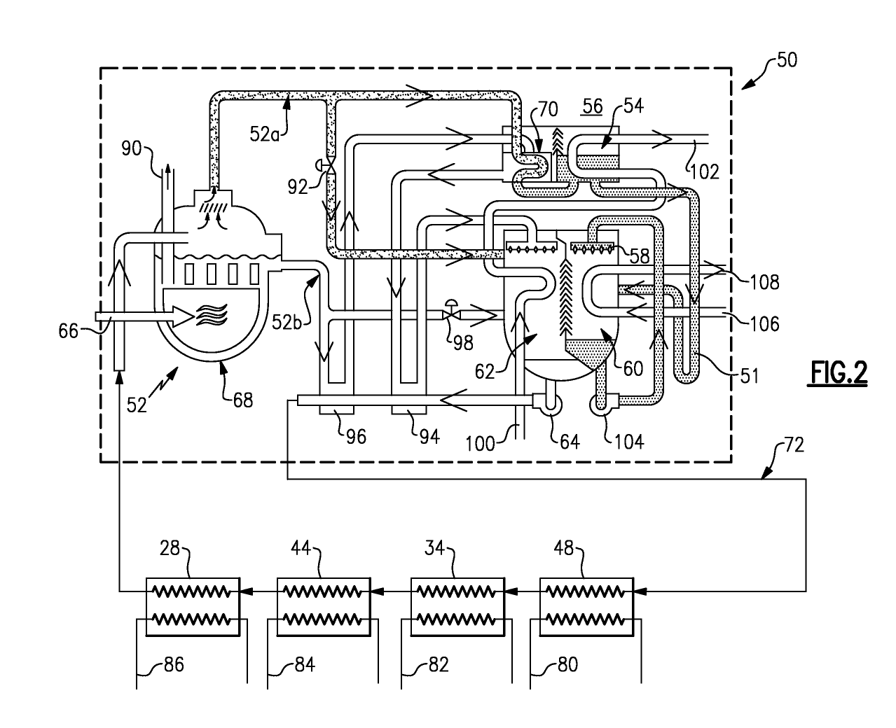

Referring to FIG. 2, a refrigerant system 50 is integrated into the system 10 to efficiently provide a sufficient cooling capacity for dissipating waste heat from the heat exchangers in the system 10. The arrows indicate flow direction. An absorber 62 has a solution of the refrigerant and the absorbent. The refrigerant system 50 includes an absorbent loop 52 having primarily absorbent and a refrigerant loop 51 having primarily refrigerant. The absorbent is typically a lithium bromide or ammonia solution, and the refrigerant is typically water.

In the example, the example refrigerant system 50 is a double-effect absorption cycle refrigerant system having first and second generators 68, 70 that act as “thermal compressors.” In the example, a solution pump 64 is configured to provide the solution to the first and second generators 68, 70. The absorber 62 is fluidly connected to a first generator 68 that is configured to receive the solution. A heat source 66, which may be a natural gas combustor, is configured to heat the first generator 68 and increase a pressure of the absorbent. The double-effect arrangement includes a second generator 70 in fluid communication with and downstream from the first generator 68.

The absorbent loop 52 includes a refrigerant gaseous flow path 52a and a concentrated absorbent liquid flow path 52b. In one branch of the refrigerant gaseous flow path 52a, refrigerant is provided from the first generator 68 to a condenser 54 where the refrigerant from the gaseous flow path 52a is condensed to provide liquid refrigerant for the refrigerant loop 51. In an alternative heating (non-chilling) mode, the refrigerant is also provided from the gaseous flow path 52a through a regulating valve 92 to an absorber 62. In either case, absorber 62 supplies absorbent to the first generator 68 through a solution return line 72 using the solution pump 64. The solution return line 72 is part of both the absorbent and refrigerant loops 52, 51. Exhaust gas is expelled from the first generator 68 through exit 90.

The liquid flow path 52b interconnects the first generator 68 (high temperature) to the second generator 70 (low temperature). A high temperature heat exchanger 96 is arranged in the liquid flow path 52b between the first and second generators 68, 70. A low temperature heat exchanger 94 is arranged in the liquid flow path 52b between the second generator 70 and the absorber 62, where liquid absorbent is deposited. Liquid absorbent can also return to the absorber 62 and bypass the second generator 70 through regulating valve 98.

A cooling water flow path provides cooling water between a cooling water inlet and outlet 100, 102. The cooling water flow path passes through the absorber 62 and condenser 54 to transfer heat between the cooling water and absorber 62 and condenser 54 and condense absorbent and refrigerant, respectively.

An evaporator 60 removes waste heat from the refrigerant loop 51. The condenser 54 is arranged fluidly upstream from a device 58 that acts as an expansion valve. A pump 104 circulates the refrigerant within the refrigerant loop 51 to provide chilled water to a chilled water outlet 108 using water provided from a chilled water inlet 106. The cooling water and the chilled water are received from and provided to a facility, for example.

The heat exchangers 28, 34, 44, 48 are arranged downstream from the solution pump 64 and fluidly between the high and low temperature heat exchangers 96, 94 and the first generator 68. The heat exchangers 28, 34, 44, 48 respectively include fluid passages 86, 82, 84, 80 that carry fluids from the system 10.

In operation, heat is applied to the solution of refrigerant and absorbent within the first and second generators 68, 70 to increase the pressure of the solution. The refrigerant and absorbent are separated in the absorber 62 and the first and second generators 68, 70. The refrigerant is passed through the condenser 54, which rejects heat to a heat sink 56, such as ambient air, to the expansion valve 58. The refrigerant exiting the device 58 decreases in pressure. The part of the refrigerant vapors are absorbed by the absorbent injected into absorber 62, thus cooling the remaining refrigerant and the chilled water loop between 106 and 108 in evaporator 60.

The heat exchangers 28, 34, 44, 48 receive the dilute absorbent solution from the solution pump 64, downstream from the low and high temperature absorbent heat exchangers 94, 96. In the example, the heat exchangers are arranged in order of increasing temperatures. However, the heat exchangers may be different in terms of the amount of thermal energy they may add to the stream

Example temperatures associated with the hot streams in heat exchanger 48 is 49° C. and may contribute around 20-40% of the overall thermal energy available. Heat exchanger 34 may have a hot side temperature of 60° C. and may typically contribute around 5-10% of the overall thermal energy, for example. Heat exchanger 44 may have a hot side temperature of around 100-135° C. and contribute around 40-60% of the overall thermal energy. Heat exchanger 28 may have a hot side temperature of greater than 135° C., for example, and contribute from 5-15% of the overall thermal energy into the stream 72.

Said another way, the cathode exhaust heat exchanger 48 has a lower temperature than the cooling heat exchanger 34; the cooling heat exchanger 34 has a lower temperature than the coolant heat exchanger 44; the coolant heat exchanger 44 has a lower temperature than the reformate heat exchanger 28. Fluid from the fuel cell system 10 flows through the fluid passages 80, 82, 84, 86 of the heat exchangers 48, 34, 28, 44. The cooled solution flows in the solution return line 72 through the heat exchangers 48, 34, 44, 28 to efficiently cool the fuel cell system 10 and increase the temperature of the solution.

Although example embodiments have been disclosed, a worker of ordinary skill in this art would recognize that certain modifications would come within the scope of the claims. For that reason, the following claims should be studied to determine their true scope and content.

1. A fuel cell system comprising:
a cell stack assembly including an anode, a cathode and a coolant portion;
at least one heat exchanger fluidly interconnected with at least one of the anode, the cathode and the coolant portion configured to provide a fluid path having a fluid, the at least one heat exchanger configured to receive the fluid from the at least one of the anode, the cathode and the cooling portion; and
an absorption cycle refrigerant system including an absorber having a solution of refrigerant and absorbent, and an absorbent loop and a refrigerant loop communicating with the absorber and respectively carrying absorbent and refrigerant, the at least one heat exchanger arranged in at least one of the absorbent and refrigerant loops and configured to transfer heat from the fluid to the absorbent.

2. The fuel cell system according to claim 1, wherein the absorber fluidly connected to a generator that is configured to receive the solution, and a heat source configured to heat the generator and increase a pressure of the solution.

3. The fuel cell system according to claim 2, wherein the absorbent loop includes a pump configured to provide the solution to the generator.

4. The fuel cell system according to claim 2, comprising a second generator in fluid communication with and downstream from the generator and configured to receive the solution from the generator and further increase the pressure of the solution.

5. The fuel cell system according to claim 1, comprising a fuel source configured to provide fuel and that is in fluid communication with and upstream from the anode, the at least one heat exchanger arranged in fluid communication with the anode and configured to receive the fluid, which includes the fuel, the at least one heat exchanger is a reformate heat exchanger configured to receive a reformate derived from the fuel.

6. The fuel cell system according to claim 1, comprising a cooling loop including a coolant heat exchanger in fluid communication with and downstream from the cooling heat exchanger, the coolant heat exchanger arranged in fluid communication with the coolant portion.

7. The fuel cell system according to claim 6, wherein the at least one heat exchanger includes a cooling heat exchanger in fluid communication with the coolant heat exchanger and another heat exchanger.

8. The fuel cell system according to claim 7, wherein the other heat exchanger is a cathode exhaust heat exchanger configured to receiving cathode exhaust from the cathode, the at least one heat exchanger including the cathode exhaust heat exchanger.

9. The fuel cell system according to claim 1, wherein the at least one heat exchanger is in fluid communication with and downstream from the cathode and configured to receive cathode exhaust.

10. The fuel cell system according to claim 9, comprising a cooling heat exchanger arranged in a coolant loop and in fluid communication with and arranged fluidly between the coolant portion and the at least one heat exchanger.

11. The fuel cell system according to claim 2, wherein the at least one heat exchanger is arranged in a solution return line fluidly interconnecting the absorber and the generator with the absorber in an upstream location from the generator.

12. The fuel cell system according to claim 2, comprising first and second heat exchangers respectively carrying first and second fluids from the cell stack assembly that respectively include first and second temperatures, the second temperature greater than the first temperature, the first and second heat exchangers arranged in the absorbent loop with the second heat exchanger fluidly arranged downstream from the first heat exchanger with both heat exchangers between the absorber and the generator.

13. The fuel cell system according to claim 1, wherein a condenser is arranged in both the absorbent and refrigerant loops upstream from the absorber.

14. A method of cooling a fuel cell comprising:
producing electricity with a fuel cell that includes an anode, a cathode and a coolant portion;
applying a heat to a solution of refrigerant and absorbent to increase a pressure of the solution;
separating the refrigerant and absorbent into a refrigerant loop and an absorption loop;
returning the refrigerant and absorbent to an absorber;
decreasing the pressure and temperature of the solution to provide cooled solution; and
passing a fluid within at least one of the anode, cathode and coolant portion through a heat exchanger, and passing the cooled solution through the heat exchanger to cool the fluid to provide cooled fluid to the fuel cell.
